(19) United States
(12) Patent Application Publication
(10) Pub. No.: US 2026/0156161 A1
(43) Pub. Date: Jun. 4, 2026

(54) System And Method for Multi-Tasking While Safeguarding Computing Devices and Associated Data Communications

(71) Applicant: ByteRail Inc., Toronto (CA)

(72) Inventors: Joseph John BARFETT, London (CA); Matthew MACCARONE, Las Vegas (CA)

(73) Assignee: ByteRail Inc., Toronto, ON (CA)

(21) Appl. No.: 19/459,232

(22) Filed: Jan. 26, 2026

Related U.S. Application Data
(63) Continuation of application No. PCT/CA2025/051027, filed on Jul. 31, 2025.
(60) Provisional application No. 63/677,695, filed on Jul. 31, 2024.

(51) Int. Cl. H04L 9/40

(52) U.S. Cl. CPC H04L 63/20

(57) ABSTRACT

System and method are provided for multi-tasking while safeguarding computing devices and associated data from unauthorized access especially when communicating over networks. The system includes a linking device configured to connect a host device to at least one auxiliary computing device which may run unique software independent of the host or be connected to an external network. The linking device includes a capture device that captures output data feed from the auxiliary device and generates a passive data feed. The output data feed may include information received by the auxiliary device The linking device also includes a first and second communication channel. The first channel allows transmission of passive data feed from capture device to host device for display. The second channel enables transmission of control signals from host device to auxiliary device. The control signals represent one or more input signals received by host device from a user via input devices connected to the host device.

### CROSS-REFERENCE TO RELATED APPLICATION(S)

This application is a continuation of PCT Patent Application No. PCT/CA2025/051027 filed on Jul. 31, 2025, which claims priority to U.S. Provisional Patent Application No. 63/677,695 filed on Jul. 31, 2024, the entire contents of which are incorporated herein by reference.

### TECHNICAL FIELD

The following relates generally to multi-tasking of software applications, cyber security systems and methods, and more particularly, to a system and method for safeguarding computing devices and associated data communications from unauthorized access while maintaining user-friendly multi-tasking.

### BACKGROUND

In modern organizational environments, computing systems are widely interconnected to facilitate both internal collaboration and external communication. Workstations, laptops, tablets, and other computing devices routinely operate in networked configurations that include access to internal networks, such as corporate intranets, and external networks, such as the public Internet. It is common for multiple applications to be simultaneously running on these computers which are often situated or require data from several different networks, including a combination of native applications on a local hard drive, file access from a local intranet, and email or productivity software on a cloud server. These systems are often required to handle sensitive or confidential information, including proprietary business data, financial records, customer information, and intellectual property.

To support operational efficiency, it is common for a computing device within an organization to be simultaneously connected to both an internal network and an external network. For example, a user workstation may access internal databases or file servers over a local area network (LAN) or virtual private network (VPN), while also browsing the Internet or using web-based applications through a separate connection. Sometimes this integration of networks occurs for convenience, for example the access of email may be on a cloud while word processing and spreadsheets are internal on an intranet. Sometimes, the applications themselves require dedicated hardware such as specialized GPU resources which can be provided on specialized machines on a server or alternatively on a cloud, such as for example corporate web services. Although dual connectivity enhances accessibility and flexibility, it can introduce substantial cybersecurity vulnerabilities.

One of the risks in such configurations is the possibility of unauthorized access by external attackers. A compromised Internet-facing application, malicious download, or phishing attempt may allow malware to infiltrate a host computer. Once compromised, the host may act as a conduit for attackers to penetrate the internal network, thereby exposing sensitive resources that would otherwise be inaccessible from the outside. In more advanced attacks, malicious software may operate silently in the background, exfiltrating data or manipulating internal systems without detection.

Traditional cybersecurity solutions, such as firewalls, antivirus software, and intrusion detection systems, provide important layers of protection but are not always sufficient to address sophisticated or zero-day threats. These tools often rely on known threat signatures or behavior patterns, which may fail to detect novel attacks. Moreover, they do not eliminate the fundamental risk created by a system that is simultaneously exposed to both trusted and untrusted network environments.

As organizations continue to digitize and distribute their operations, the potential for cybersecurity breaches becomes increasingly significant. There is, therefore, a need for improved systems and methodologies that can isolate trusted computing environments from untrusted data sources and prevent unauthorized access to confidential information, even in the presence of a compromised device or network pathway.

### SUMMARY

In one aspect, a system for multitasking while safeguarding computing devices and data associated with computing devices from unauthorized access is provided. The system includes at least one linking device configured to connect a host computing device to at least one auxiliary computing device. The linking device includes a data conversion device configured to capture an output data feed from the auxiliary computing device and provide a passive data feed; a first communication channel configured to transmit the passive data feed from the data conversion device to the host computing device for display on an output device associated therewith; and a second communication channel for transmitting control signals from the host computing device to the auxiliary computing device, the control signals being representative of one or more input signals received by the host computing device from a user via one or more input devices connected to the host computing device.

In another aspect, there is provided a method for multitasking while safeguarding computing devices and data associated with computing devices from unauthorized access, the method comprising: connecting, by at least one linking device, a host computing device to at least one auxiliary computing device; capturing, by a data conversion device, an output data feed from the auxiliary computing device and providing a passive data feed; transmitting, by a first communication channel, the passive data feed from the data conversion device to the host computing device for display on an output device associated therewith; and transmitting, by a second communication channel, control signals from the host computing device to the auxiliary computing device, the control signals being representative of one or more input signals received by the host computing device from a user via one or more input devices connected to the host computing device.

The system and method described in the present disclosure can provide various technical advantages. Advantages of the above include, for example, that the host device and any data and/or intranet connected to it, where sensitive data is stored, remain inaccessible to a hacker even if they managed to access a auxiliary device via the Internet. Moreover, the number of processes that can be executed can be restricted by the auxiliary device and malware would then be unable run on a auxiliary device that can only be used to run a specific program such as an email application or browser, as unexpected processes can be made to end immediately. Because malware cannot run, the need for expensive anti-virus software is reduced.

### BRIEF DESCRIPTION OF THE DRAWINGS

Embodiments will now be described with reference to the appended drawings wherein:

FIG. 1 illustrates an example system for safeguarding a host computing device and data associated with the host computing device from unauthorized access when communicating over an external network.

FIG. 2 illustrates an example first data transfer pipeline configured to enable passive data transfer from an auxiliary computing device to the host computing device.

FIGS. 3a and 3b illustrate example second and third data transfer pipelines configured to enable data transfer from the host computing device to the auxiliary computing device.

FIG. 4 illustrates a second example implementation of the system for safeguarding a host computing device and data associated therewith from unauthorized access when communicating over the external network.

FIG. 5 illustrates an example interface displayed on an output device connected to the host computing device.

FIG. 6 illustrates a flowchart for an example method of safeguarding a host computing device and data associated therewith from unauthorized access when communicating over an external network.

### DETAILED DESCRIPTION

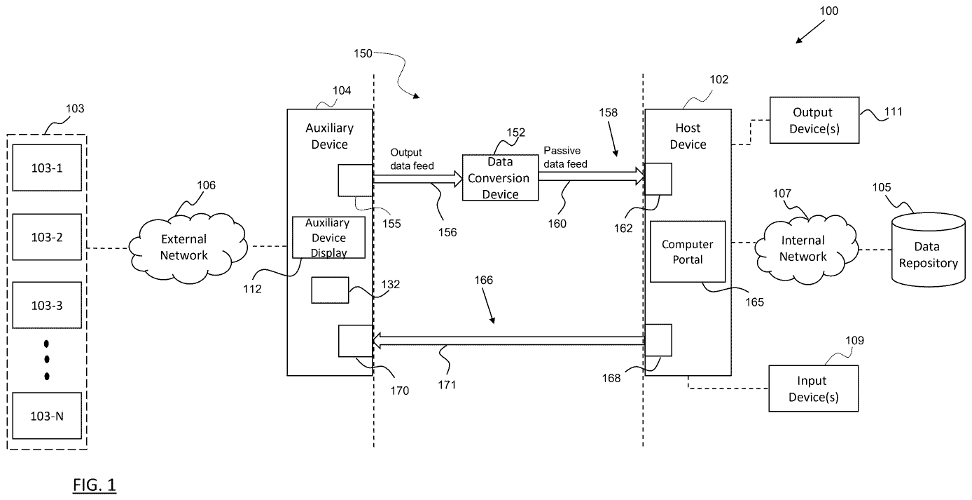

The present disclosure relates to a system and method for safeguarding data communications of a host computing device, for example, from unauthorized access, when communicating with an external network, such as the Internet. FIG. 1 illustrates an example system 100 for safeguarding a host computing device 102 and data, such as that stored in a data repository 105 associated or otherwise connected to the host computing device 102. In an example implementation, the host computing device 102, hereinafter referred to as the host device 102, can be implemented as a workstation associated with an organization, such as a hospital, a financial institution, corporate organization, and the like and may be connected to the organization's data repository 105 via an internal network 107. For example, the internal network 107 may be implemented as an Intranet, a local area network (LAN), or any other wired or wireless private communication infrastructure maintained by the organization. Further, in some example implementations, the data repository 105 can include a one or more of databases, application servers, file storage systems, user terminals, or other computing resources associated with the organization that are accessibly by a user (such as an employee of the organization or any other authorized personnel) via the host device 102. In one example, the data repository 105 can store data including, but not limited to, documents, pictures, music, videos, programs and application data and user preferences.

In some examples, the host device 102 can be an independent device and the data repository 105 can be the local data storage device associated with the host computing device 102.

In an example implementation, the host device 102 may include any computing device capable of executing instructions and communicating over a network, including but not limited to a desktop computer, laptop, tablet, smartphone, server, or other processing enabled device. The host device 102 can include or is otherwise connected to one or more peripheral input devices 109 configured to enable the user to provide input to the host device 102. The peripheral input devices 109 can include, but are not limited to, keyboard, mouse, stylus, game controller, pointer, touchscreen, and the like. The host device 102 can further include one or more peripheral output devices 111, such as a display monitor, speaker, touchscreen, and the like. The host device 102 may additionally include a memory unit, a processor, one or more communication interface components (not shown) and so on that cooperate to enable the various functionalities and communication capabilities of the host device 102 as described herein.

The memory unit can include any of the volatile memory elements (e.g., random access memory (RAM), non-volatile memory elements (e.g., ROM), Hard Disk Drives (HDDs), Solid-State Devices (SSDs) and/or other transitory or non-transitory computer-readable media. The memory unit can include one or more software programs, each of which includes listing of computer executable instructions for implementing logical functions associated with the functioning of the host device 102. The software in the memory unit can include a suitable operating system and one or more programming codes for execution by the components, such as the processor of the host device 102. The operating system can be configured to control the execution of the programming codes and provide scheduling, input-output control, file and data management, memory management, and communication control, and related services. The programming codes may be configured to implement the various processes, algorithms, methods, techniques, etc. described herein. Further, the processor can be a hardware device for executing software instructions, such as the software instructions stored in the memory unit.

The processor can include one or more of a custom made or commercially available processor, a central processing unit (CPU), an auxiliary processor among several processors associated with the processor, a semiconductor-based microprocessor, or generally any device for executing software instructions. The processor can be implemented using one or more controller technologies, such as Application Specific Integrated Circuit (ASIC), Reduced Instruction Set Computing (RISC) technology, Complex Instruction Set Computing (CISC) technology, and so on. When the host device 102 is in operation, the processor can be configured to execute software stored within the memory unit to generally control and perform the one or more operations of the host device 102 pursuant to the software instructions. Further, in some implementations, the communication interface can include a transceiver configured to transmit and receive data to/from various devices operating during the detection process. The transceiver can transmit and receive data/messages in accordance with various communication protocols, such as, TCP/IP, UDP, and 2G, 3G, 4G, 5G or 6G communication protocols. Further, the communication interface can also include, for example, an Ethernet card or adapter or a wireless local area network (WLAN) card or adapter.

Generally, the data repository 105 can include confidential data that is only accessible to authorized personnel, such as via the host device 102 over the internal network 107, associated with the organization. Therefore, connecting the host device 102 directly to an external network, such as the Internet, can potentially pose a significant security threat to the host device 102 and the confidential data associated with the host device 102. For example, in an organization, the most common Information Technology (IT) setup is a reasonably powerful computer connected to both an internal or intranet network and the external network, such as the internet. It is common for the internal network or intranet to be connected to the internet and for a local workstation to access the Internet through the intranet. Thus, a user can access the sensitive data (such as that within the data repository 105, for example) as well as send email or access the Internet through a web browser. Another common setup is for a computer to access intranet through a hardline or Virtual Private Network (VPN), and Internet through a separate connection such as a wireless connection. However, both set-ups have major security flaws. For instance, access to the host computer 102 by a hacker can enable access to the intranet and the sensitive data connected to it or may lead to the corruption or crash of the intranet, data, or the associated software altogether.

To that end, in an embodiment, the present disclosure provides an auxiliary device 104 that can be coupled to the host device 102 via a linking device 150 for safeguarding the host device 102 and the associated data from unauthorized access, such as when the host device 102 communicates with one or more external data sources 103 (such as the sources 103-1, 103-2, 103-3 . . . 103-N) over an external network 106, such as the Internet. With multiple auxiliary devices 104, one could, for example, allow only certain applications to run on specific ones of the auxiliary devices 104. We can perhaps put that into the specification The external network 106 can be the Internet in some examples or can be any other external network that is not part of the organization's internal network. The external data sources 103 can include any web pages, web portals, applications, and so on that are external to the organization and can be accessed only via the external network 106.

In an example implementation, the auxiliary device 104 can be any computing device of modest power, such as a simple Linux computer, compared to host computing device 102. In some other examples, the auxiliary device 104 can be a separate standalone computing device with equivalent processing power as that of the host device 102. In various examples, the auxiliary device 104 can be implemented as, for example, a desktop computer, laptop, tablet, smartphone, server. Similar to the host device 102, in some examples, the auxiliary device 104 can also include its respective output device, such as a auxiliary device display 112, processor, memory unit, and one or more communication interfaces. In some other examples, although not needed for the purposes of this disclosure, the auxiliary device 104 can also optionally include its own set of peripheral input and output devices. The auxiliary device 106 can be configured to run a respective one or more software application or programs and is connected to the external network 106 via a wired or wireless connection. The auxiliary device 104 may include a control software or a controller that can be plugged into the auxiliary device 102 via a USB or “thumb” drive, and can be configured to limit applications and processes that can run on the auxiliary device 104. Although FIG. 1 shows a single auxiliary device 104 connected to the host device 102, in some other example implementations, the host device 102 can connect to any number of auxiliary devices 104. In such examples, each auxiliary device 104 can be configured to run a specific software and/or application to communicate with the external network 106 and the host device 102 can switch between these auxiliary devices 104 to access the respective applications over the external network 106. For instance, one auxiliary device 104 can be configured to run web browser and another auxiliary device 104 can be configured to run Microsoft Outlook® and a yet another auxiliary device 104 can be configured to run a video conferencing application such as Webex®. A user can access the respective applications on the host device 102 by opening the respective window corresponding to the individual auxiliary devices 104. Such multi-auxiliary devices configuration will be described in further detail later in the following description.

In an embodiment, the linking device 150 is configured to connect the host device 102 to the auxiliary device 104 which in turn is connected to the external network 106, thereby enabling the host device 102 to communicate with the external network 106 through the auxiliary device 104. For example, the auxiliary device 104 is connected to the external network 106 while the host device 102 and consequently the internal data repository 105 associated with the host device 102 remains disconnected from the external network 106 and are connected only to the internal network 107. Therefore, a user cannot access the external network 106 directly from the host device 102 and will require such access via the auxiliary device 104. For example, the auxiliary device 104 may be configured to run a web browser such as Chrome® that can be displayed on the auxiliary device display 112 and the same can be passively transmitted and displayed on the respective peripheral output device 111 connected to the host device 102 via the linking device 150, as will be described in greater detail below.

In an embodiment, the linking device 150 is a combination of hardware and software components that enable a physical connection and a secure communication channel between the host device 102 and the auxiliary device 104. In an example implementation, the linking device 150 can be implemented as a standalone device that can be plugged into a port, such as Universal Serial Bus (USB) port provided in each of the host device 102 and the auxiliary device 104. The corresponding software to enable functioning of the linking device 150 can be downloaded on the host device 102 to implement the connection between the host device 102 and the auxiliary device 104 in the manner described herein. Therefore, if a user needs access to the external network 106, they can simply plug in the linking device 150 to the host device 102 and any auxiliary device 104 (such as a personal computer or mobile phone acting as the auxiliary device 104) to enable access to the external network 106 on the host device 102 through the auxiliary device 104. In some other examples, the linking device 150 can be implemented as part of or in combination with the auxiliary device 104, which can be connected to a corresponding connection port provided on the host device 102 to establish the connection.

In an embodiment of the present disclosure, the linking device 150 includes a data conversion device 152 which may be in some implementations configured to capture an output data feed generated by the auxiliary device 104 to generate a passive data feed to be transmitted for display on the output device 111 associated with the host device 102.

To that end, in an example implementation, the auxiliary device 104 can include monitor port 155 (e.g., using a High-Definition Multimedia Interface (HDMI) port or equivalent device) that is configured to output a media feed (including video and audio output) corresponding to the application being run or displayed on the auxiliary device display 112 of the auxiliary device 104. That is, when the web browser is run on the auxiliary device 104 and the device 104 communicates with the external network 106, the entire visual and/or audio data displayed on the display 112 of the auxiliary device 104 is converted into a media feed as the output data feed and output via the monitor port 155. Further, the output data feed includes the information received from the external network 106 such as when the auxiliary device 104 communicates with one or more external data sources 103 via the network 106. A streaming cable 156 (e.g., HDMI steaming cable) can be connected to the monitor port 155 and configured to transfer the output data feed to the conversion device 152.

In some examples, the auxiliary device 104 may include a Graphics Processing Unit (GPU) 132 for processing video or audio data to be transmitted to the host device 102. The GPU 132 can be configured to filter unwanted content from the auxiliary device 104 prior to it being presented to the host device 102. For example, the GPU 132 can run a deep learning model to filter unwanted content received by the auxiliary device 104. For example, the GPU 132 can be configured to run a Deep Neural Network (DNN) to filter out offensive images, text, video or sound before the data is transmitted to the host device 102 and presented to the user. The user can decide which content is offensive by teaching and/or training model and can also select replacement content to replace these offensive data. For example, the model can be trained to remove offensive and/or unwanted content (for example, advertisements, crude content, offensive or explicit images or foul language) in a video or audio feed and replace this content with replacement content (for example, educational or healthy content). This filtering function can be used to protect the user from browsing this offensive/unwanted content. Accordingly, in such implementations, the output data feed is a refined output data feed that is finally transmitted to the host device 102.

Alternatively, in some other examples, the host device 102 can include the GPU instead of the auxiliary device 104. In such implementations, the GPU on the host device 102 can be configured to process the received data feed to detect if there is any offensive/unwanted/sensitive data. For example, the GPU in the host device 102 can be configured to run a DNN to filter out offensive images, text, video or sound before the data is displayed on the output device 111 of the host device 102, in a similar manner as described above. The user can decide which content is offensive by teaching and/or training the model and can also select replacement content to replace this offensive content, as done by the GPU 132 located on the auxiliary device 104 as discussed above.

In an embodiment, the conversion device 152 is implemented as an HDMI capture device or any other screen “capturing” device that is configured to capture or record the HDMI feed of the screen displayed on the auxiliary device 104 and generate a passive data feed to be relayed or transmitted to and displayed on the display device 111 of the host device 102. The term “passive data feed” can refer to the recorded or captured HDMI feed that is received or observed without active interaction, control, and/or transmission back to the source, i.e., the auxiliary device 104. Since the passive data feed is merely a screen capture or recording of the HDMI data feed, it cannot be hacked. Further, there is no way someone can send malware through an HDMI feed and even if they, the malware can only be transmitted to the conversion device 152 as the host device 102 only receives the screen capture or the passive data feed. This way, the host device 102 and the associated data repository 105 can remain protected against any cyber security threats.

The conversion device 152 is in turn connected to the host device 102 via a first communication channel 158. In an example implementation, the first communication channel 158 can, optionally as shown in dashed lines, include a physical USB cable or hub 160 connected to a corresponding computer port 162 provided in the host device 102. In some other implementations, other physical connection can be used to transfer the passive data feed from the conversion device 152 to the host device 102. In some yet other examples, any other wireless or digital transfer medium can be used to transfer the passive data feed to the host device 102.

In an embodiment, the host device 102 can include a computer portal 165 configured process and convert the received passive data feed for display on the output device 111 connected or associated with the host device 102. In an example implementation, the computer portal 165 can be implemented as an OpenCV module running on the host device 102 and configured to display the received passive data feed in a window on the display monitor (output device 111) of the host device 102. In one implementation, the computer portal 165 can enable or display an auxiliary device icon corresponding to the auxiliary device 104 on the display monitor, for example, in a window of the host device 102. Therefore, when the user launches the auxiliary device icon, the computer portal 165 can start displaying the received passive data feed (in real time or near real-time) on the window displayed on the output device 111 of the host device 102. In operation, when the user launches the auxiliary device icon, the window interface displayed on the host device 102 is a screen record of the actual window running on the auxiliary device 104. Now, the user can view the information accessed by the auxiliary device 104 over the external network 106 on the display monitor of the host device 102.

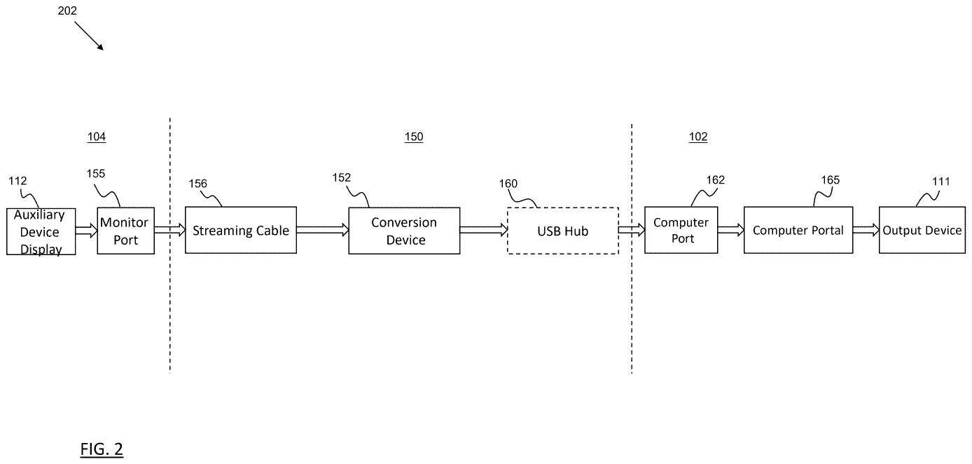

In an example implementation, as shown in FIG. 2, the auxiliary display device 112, the monitor port 155, the streaming cable 156, the conversion device 152, the optional USB hub 160, the computer port 162 and on the host device 102 define a unidirectional data flow channel or pipeline 202 for enabling passive data transfer representative of the auxiliary device output feed from the auxiliary device 104 to the host device 102. This unidirectional data flow channel is configured to permit only transmission of data such as the passive data feed from the auxiliary device 104 to the host device 102, as explained above, and prohibit any data flow in the opposite direction, i.e., from the host device 102 to the auxiliary device 104. This way, any security threat to which the auxiliary device 104 may get exposed to would be restricted from gaining any access any data from the host device 102, the internal network 107, and/or the data repository 105.

Referring back to FIG. 1, the linking device 150 further includes a second communication channel 166 configured to enable transmission of input control signals from the host device 102 to the auxiliary device 104. In an example implementation, the second communication channel 166 is an analog communication channel configured to permit transmission of input control signals from the host device 102 to the auxiliary device 104. For example, when the user interacts with the external network 106 from the host device 102 via the auxiliary device 104, they use the peripheral input devices 109 to provide input control signals to the host device 102. These input control signals are processed or converted into control signals by the computer portal 165 for transmission over the second communication channel 166 to the auxiliary device 104. For example, the computer portal 165 captures the input signals provided by the user by capturing the corresponding mouse and keyboard manipulation displayed on the display device 111 of the host device 102. In an example implementation, the computer portal 165 can capture and convert the keyboard data into a transmission format, such as ASCII, and the mouse movement data in the form of mouse coordinates, for transmission over the second communication channel 166 to the auxiliary device 104.

In an embodiment, the host device 102 includes a first control device or a first microcontroller 168 and the auxiliary device 104 similarly includes a second control device or a second microcontroller 170 configured to communicate with each other, for example, by pin readout, to establish the analog second communication channel 166 for transmitting the input control signals from the host device 102 to the auxiliary device 104. The first and second microcontrollers 168 and 170 can be implemented as using any combination of software and hardware including programmable chips, such as Arduino boards and the like. The first and second microcontrollers 168, 170 can be connected to each other by a transmission unit 171 implemented as a physical cable or a USB drive, in some examples, to establish the analog communication channel by means of a pin to pin connection implementing pin readout. To that end, the first microcontroller 168 can include one or more GPIO (general-purpose input/output) pins that communicate with the corresponding GIPO pins provided on the second microcontroller 170 to enable transmission of input control signals. In one embodiment, the GIPO pins on the first and second microcontrollers 168, 170 are connected to one another via one way diodes to enable or permit a unidirectional data transmission, that is from the host device 102 to the auxiliary device 104 and prohibit any data transfer in the opposite direction, i.e., from the auxiliary device 104 to the host device 102.

In operation, the computer portal 165 can capture the input signals from the peripheral input devices 109 that are then converted by the first microcontroller 162 on the host device 102 into electrical signals that are sent via the pin of the first microcontroller 168 to the pin of the second microcontroller 170 on the auxiliary device 104. The second microcontroller 170 receives the electrical signals from the first microcontroller 162 and converts into corresponding keyboard and mouse movement data that is displayed on the screen and application being run on the auxiliary device 104. As the user transmits input signals using the host device 102, the input signals are received by the second microcontroller 170 which functions like a simulated mouse and keyboard on the auxiliary device 104. This enables the functionality of the peripheral input devices on the auxiliary device 104 without requiring the dedicated hardware. Further, as explained above, since the display screen of the auxiliary device 104 is continuously captured and displayed on the display monitor 111 of the host device 102 via the first pipeline 200, the user can view the same on the window displayed on the host device 102 in real time or near real-time. This gives the user a comfort and perception as if they are accessing the external network 106 directly from the host device 102 while preventing the host device 102 from actually connecting directly to the external network 106.

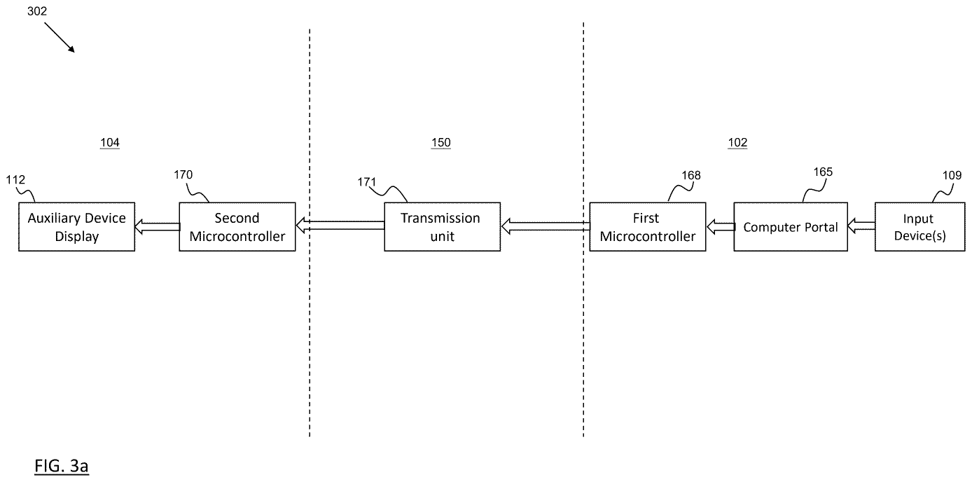

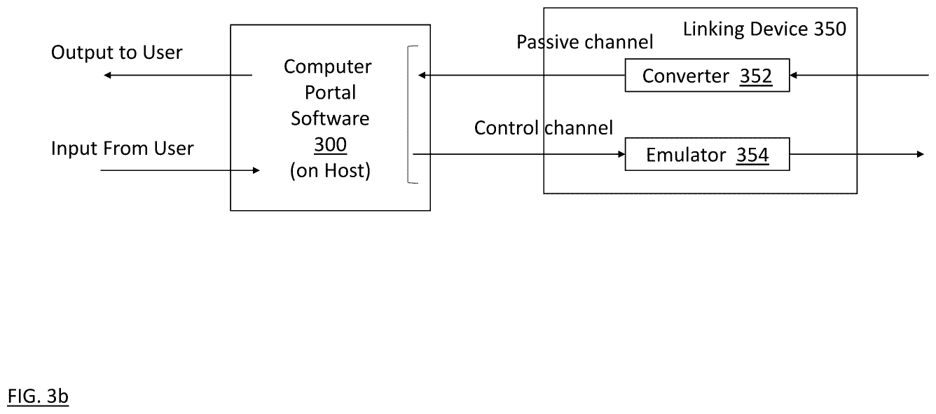

As shown in FIG. 3a, the peripheral input devices 109, the computer portal 165, the first microcontroller 168, the transmission unit 171, the second microcontroller 170 and the auxiliary device display 112 form a second unidirectional data flow channel or pipeline 302. This unidirectional data flow channel is configured to permit only transmission of electrical control signals from the host device 102 to the auxiliary device 104, as explained above, and prohibit any data flow in the opposite direction, i.e., from the auxiliary device 104 to the host device 102. This way, any security threat to which the auxiliary device 104 may get exposed to would be restricted from gaining any access any data from the host device 102, the internal network 107, and/or the data repository 105.

In this way, the user may open an access window on the auxiliary device 104 via the display device 111 of the host device 102 to communicate with the one or more data sources 103 and the external network 106, such as the Internet. The unidirectional passive data transfer from the auxiliary device 104 to the host device 102 and the analog control signal transmission from the host device 102 to the auxiliary device 104 protects the host device 102 from being exposed to cyber threats and unauthorized access.

Further, computer users often perform multitasking on multiple different machines. For example, a computer at work may be a Linux workstation and a user may bring a separate laptop to run software requiring a different operating system such as Windows® or macOS®, and may, in some examples, also use a smart phone for routine communications. Even on a large computer such as the workstation, multitasking has limitations in that all software must be compatible with the native operating system. This scheme made sense prior to the era of multiple independent operating systems with their own unique software ecosystems, prior to the internet when hacking and data vulnerability were less important, prior to extensive software reliance on specific dedicated hardware such as graphical processing unit (GPU) calculators which are difficult to share between programs, and also when computer programs were written in lower level languages and with smaller frameworks that did not require modern more significant processing resources, dedicated hardware, or cloud computing resources.

More solutions are needed to enable cross platform multitasking. It would be ideal to have a scheme that spread multitasking to multiple different computers linked by a common interface. The interface may be composed of their regular monitors, speakers and other peripherals for control like mouse, keyboard, microphone, midi input, etc. The independent computers may run different operating systems and software packages and may not always be cross compatible to allow seamless multitasking.

From a security point of view, current approaches to multitasking several software programs on one computer carries risk in that a hack of any one software product or data entry point can potentially lead to access of the entire system which might include the internal network. This is of particular concern for cloud-based software packages, where entry into a user's account via, for example, monitoring of keystrokes may enable remote login to a software from an alternate covert location, and may expose the rest of that user's software and hardware ecosystem to a hack. From a hardware point of view, resources such as GPUs that are needed by multiple different programs which are Artificial Intelligence (AI) powered cannot be easily shared and software which must be multitasked will conflict when attempting to share common hardware resources, necessitating a user to run two completely distinct computers. Finally, from a processing point of view, a single processor, even a multicore processor, has limitations with dramatic speed decreases as more and more processes are simultaneously utilized. This effect can be dramatic when large or complex software is run, slowing down the user experience for other software. Large software packages which use large frameworks are common today.

FIG. 3b illustrates another example in which an emulator-type linking device 350 may be used, which does not require software on the “auxiliary device” side of the connection. Here, computer portal software 300 is located on the host device 102 to provide the output to the user and obtain inputs from the user. The linking device 350 includes a converter 352 to create the passive channel and an emulator to create a control channel. The software 300 includes three primary functions, namely the pairing of channels, the software capture of the passive channel for output, and the calibration of user's input data for the emulator 354.

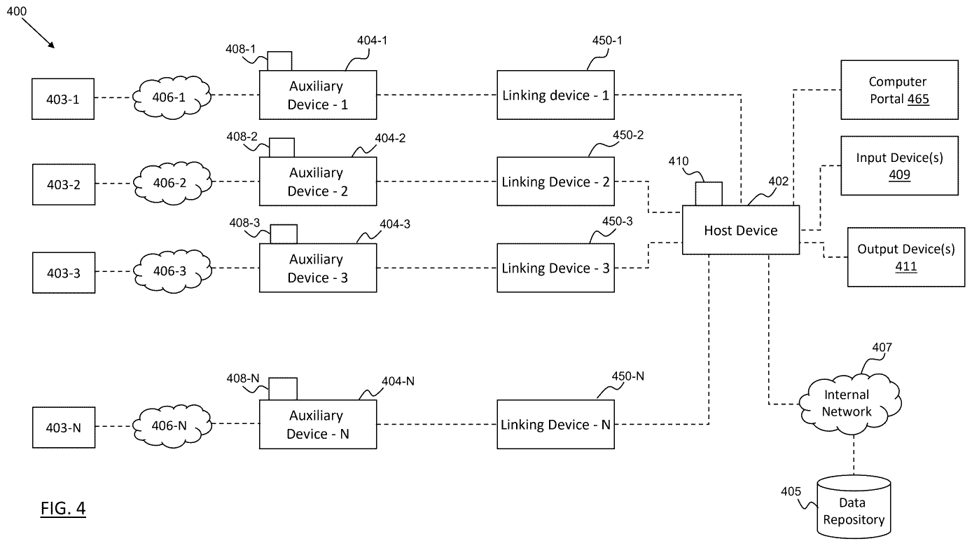

Since a auxiliary device 104, 404 may be considered a less expensive device than the host device 102, 402, there are opportunities to incorporate multiple auxiliary computers 104 into a user's computing system or computing environment. Therefore, to solve the above-noted issues, FIG. 4 illustrates an example second embodiment of the system 400 for enabling multitasking while safeguarding a host computing device 402 (hereinafter the host device 402) and the data associated with the host device 402 when the host device 402 communicates with one or more external networks. In an example implementation, a single host device 402 can be linked or connected to multiple smaller auxiliary devices, such as auxiliary devices 404-1, 404-2, 404-3 . . . 404-N which can each be dedicated to at least one specific application process. Similar to the host device 102, the host device 402 is also connected to an internal network 407 to access the internal data repository 405 within an organization. Furthermore, the host device 402 also includes a set of input peripheral devices 409 and one or more output devices or display devices 411 connected thereto and functioning similar to the input devices 109 and the output devices 111 described above.

In an example implementation, the host device 402 is connected to each auxiliary device 404 via a respective one of linking device 450 (shown as 450-1, 450-2, 450-3 . . . 450-N). Each linking device 450 functions in the same manner as described above for the linking device 150. That is, each linking device 450 includes a respective capturing device, a first communication channel to enable passive data feed from the respective auxiliary device to the host device and an analog second communication channel to enable transmission of input control signals from the host device 402 to the respective auxiliary device 404. In some example implementations, each auxiliary device 404 can be connected to their own external network 406, such as by unique internet protocol (IP) addresses or other security criteria, to obtain information from different external data sources 403. However, in some other examples, the auxiliary devices 404 may all be connected to the same external network 406 but are capable of running only a single dedicated application thereon. Each of the auxiliary devices 404 (and also the individual auxiliary device 104 shown in FIG. 1) can, in some examples, limit the number and type of applications that can be run on them. Thus, if a auxiliary device 404 can only run email or web browser, then any other unauthorized process, such as malware, cannot run and would be automatically terminated by the auxiliary device 404. Because of this, since the malware cannot run on the auxiliary device, the need for expensive anti virus software is also reduced.

In an example implementation, each auxiliary device 404 may include or be otherwise coupled to a respective control software or controller 408 (hereinafter referred to as the auxiliary controller 408) via a portal memory drive (e.g., USB or “thumb” drive) plugged into a connection port provided on the auxiliary device 404. In some example implementations, the auxiliary controller 408 may be implemented in the same manner as described above for the second microcontroller 170. In some other examples, the auxiliary controller 408 can be implemented as a separate control system that can be incorporated or be plugged into the processor of the respective auxiliary device 404 via a USB drive.

In an embodiment, the auxiliary controller 408 is configured to limit the processes that can be run on the respective auxiliary device 404. For example, the auxiliary controller 408 may only allows a single specific application, such as email or web browser, or video conferencing, etc., to be run on the respective auxiliary device 404 such that the auxiliary device 404 becomes a dedicated or designated device for that specific program. In such example implementations, the auxiliary device 404 can be configured to execute only the designated application and prohibit any other application or program from being executed thereon. Thus, a auxiliary device 404 dedicated for the email application may not be able to execute any other application, such as word processing, video conferencing, etc. To that end, if the user wants to access other applications, they can be accessed using other auxiliary devices connected to the host device 402 and designated to the specific desired application. Further, in some examples, the auxiliary controller 408 can be configured to monitor usage of the auxiliary device 404 and send statistical data to an analyzing party (such as an administrator) for analyzing the activities on the respective auxiliary device 404.

In some example implementations, a single auxiliary device 104, 404 can be configured to isolate multiple applications being run thereon. For example, the single auxiliary device 104, 404 can include multiple auxiliary controllers 408 plugged into or connected to it. In such implementations, each auxiliary controller 408 can run or support a specific application and can limit the processes that can run on the auxiliary device 104, 404.

In an embodiment, the auxiliary controller 408 can also be configured to prevent the respective auxiliary device 404 from being scripted to transfer data of large sizes from the host device 402. In an example implementation, the auxiliary controller 408 may be configured to limit data transfer by monitoring and intercepting repeated data that it encounters, or by using neural networks that look for human keystroke patterns and/or large amounts of nonsense information (i.e., encoded gibberish). For example, when monitoring the data to be transferred from the host device 402 to the auxiliary device 402, the auxiliary controller 408 can detect a string of words (such as by using optical character reader (OCR)) “The following example is for illustration only” that is repeated many times in a data input from the host device 402. The auxiliary controller 408 can detect and intercept this repeated pattern and flag the pattern as nonsense or irrelevant information which will not be transferred further to the auxiliary device 404. Although the functionality of the auxiliary controller 408 described above is with reference to the multitasking configuration shown in FIG. 4, it will be appreciated that such functionalities of the auxiliary controller 408 can be implemented in the configurations shown in FIG. 1 as well.

Further, in an example implementation, the auxiliary device 404 can include a data storage device, such as a database, configured to store different forms of data dumping (e.g., a repeated string of words or paragraphs, or any other type of gibberish information) and optionally, each form of data dumping can be labelled with a code. The auxiliary controller 408 can also be configured to run a machine learning model that can learn new patterns of data dumping from every data transfer from the host device 402 and add the new patterns of data dumping into the database storing different forms of data dumping. The prevention of data dumping by the auxiliary controller 408 can reduce the amount of data to be processed on the auxiliary device 404, thereby increasing the processing speed of the auxiliary device 404. Same is also applicable to the auxiliary device 102 as described above in FIG. 1.

In an embodiment, the host device 402 also includes a corresponding local control software or controller 410 (hereinafter referred to as the host controller 410) via a portal memory drive (e.g., USB or “thumb” drive) plugged into a connection port provided on the host device 402. In some example implementations, the host controller 410 may be implemented in the same manner as described above for the first microcontroller 170. In some other examples, the host controller 410 can be implemented as a separate control system that can be incorporated or be plugged into the processor of the host device 402 via a USB drive.

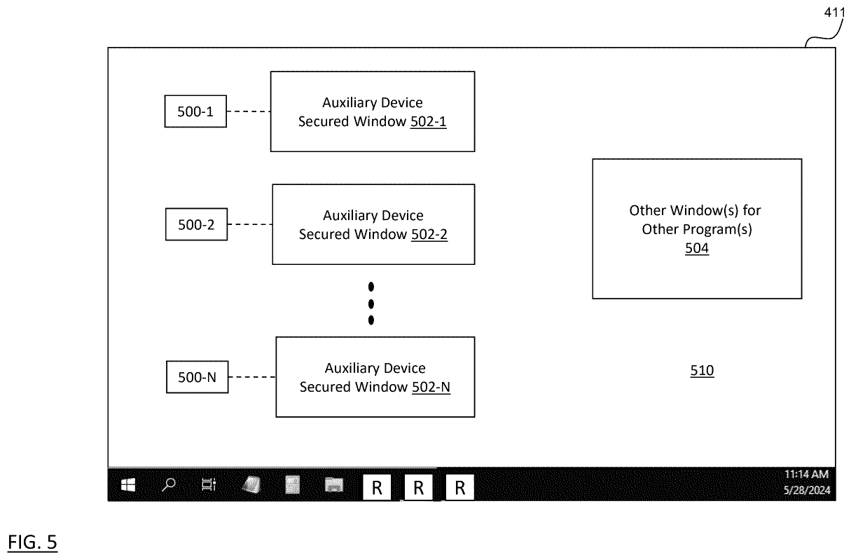

In an example embodiment, as illustrated in FIG. 5, the host controller 410 can be configured to display one or more auxiliary device icons 500-1, 500-2 . . . 500-N (collectively referred to as the auxiliary icon 500) on a display interface or window 510 displayed on the output device 411 of the host device 402. Each auxiliary device icon 500 corresponds to the respective auxiliary device 404 (or to the various applications supported by the single auxiliary device 104 connected to the host device 102) connected to the host device 402. A user can launch a particular icon 500 to establish the connection with the corresponding auxiliary device 404 associated with the selected icon to open a corresponding auxiliary device secured window 502 and start interacting with the external network(s) 406 via the auxiliary device 404 in the similar manner as described above. In some example implementations, host controller 410 is configured to monitor and limit the output data from the host device 402. The host controller 410 can also determine whether the display window for any auxiliary device 404 is active and accordingly send instructions from the input devices 409 to the corresponding auxiliary device 404 only when there is a user activity detected in the particular display window for the selected auxiliary device 404. For example, the host controller 410 can be configured to leverage the computer portal 465 to detect data inputs sent from a keyboard or a mouse of the host computer 402 when the user is typing on the keyboard or manipulating the mouse. When the user wants to switch to use another application, they can open the designated auxiliary device icon and access the desired application via the designated auxiliary device 404. While multitasking, multiple auxiliary device windows can be opened and displayed on the output device 411 of the host device 402. The computer portal 465 can detect which auxiliary device window 502 is being accessed by the user and accordingly starts detecting the input control signals provided by the user within that window 502 and establish the communication session with the corresponding auxiliary device 404 in a similar manner as described above. When the user works on other stuff on the host device 402, such as access other windows or programs 504 and is not specifically interacting with any auxiliary device window 502, the already open auxiliary device window 502 can continue to passively run in the background (without exchanging any data between the host device 402 and the auxiliary device 404) and the connection is only resumed when the computer portal 465 detects an active engagement with a particular auxiliary device window 502.

The system 400 shown in FIG. 4 and FIG. 5 enhances user experience and enables connecting to a plurality of specialized auxiliary devices via a single host device 402, which provides an alternative approach to multitasking than running multiple programs simultaneously on a single processor of a single auxiliary device 404. Further, since the display of the auxiliary devices 404 are only displayed as screen captures on the host device 402 and the input signals are transmitted as analog electrical signals from the host device 402 to the various auxiliary devices 404, the auxiliary devices and the host devices can communicate even if they do not have same or compatible operating systems. For example, one auxiliary device 404 can be Linux, another one can be Windows® or a smart phone running on a completely different operating system, all while the host device 402 is operating on a macOS®, and they will all still be able to connect with each other. This configuration makes the system seamless, efficient, and more cost effective. This also reduces the power requirements of the auxiliary devices and allows small devices with modest power capacity to support multitasking. However, in some examples, when multiple applications are run on a single auxiliary device, such as the auxiliary device 104 shown in FIG. 1, the multiple icons displayed on the host device 102 can represent the various applications and the computer portal 165 can function to detect which application is being interacted with to allow data transmission in a similar manner as described above for the configuration shown in FIG. 4. Additionally, the auxiliary devices 404 are logically and physically separate from each other and the host device 402, and thus, even if one auxiliary device 404 is compromised, other devices still remain protected.

Further, in an example, the host controller 410 (and the first microcontroller 168 shown in FIG. 1) can also monitor and determine if the data input by the user can be sent to the auxiliary device 404 via an authentication. For example, the host device 102, 402 can be paired to the user's phone via a Bluetooth connection or other short range communication protocol. The phone can implement a Client-To-Authenticator Protocol (CTAP) such that the window displayed on the output device 111, 411 of the host device 102, 402 detects the user's phone as an external authenticator. If the user wishes to send a data input from the host device 102, 402 to the auxiliary device 104, 404, an authenticator process may be initiated by sending an authentication instruction to the user's phone.

The data input in this case can only be sent out from the host device 102, 402 to the corresponding auxiliary device 104, 404 if the user of the host device 102, 402 authorizes the authentication instruction. If the user detects some unauthorized usage of the host device 102, 402 by an unauthorized party (for example, an unauthorized person trying to transfer some of the private profiles of patients stored in the hard drive of the host device 402 to an unauthorized email address), before the unauthorized party is able to send the data out, the user of the host device 102, 402 can receive an authentication request on his/her phone from the host device 102, 402 and can simply deny the authentication. In some examples, the auxiliary device 104, 404 (and its controller) can communicate with the host device 102, 402 (and its controller) through encryption unique to the memory devices used to host the two devices and their software.

In some examples, input commands from the user of the host device 102, 402 may be encoded on the host device 102, 402 and decoded on the auxiliary device 104, 404. For example, an input data of a string variable (for example, a profile of a patient at a hospital) may be encoded with a numeric variable (for example, 1, 2, 3, 4) on the host device 102, 402. The auxiliary device 104, 404 can then decode the numeric variable to the string variable referring to for example, a database storing commands before and after encoding. If the auxiliary device 104, 404 recognizes an encoded command from the host device 102, 402, the auxiliary device 104, 404 decodes the command and runs the command accordingly. If the auxiliary device 104, 404 does not recognize a command from the host device 102, 402, i.e., the command is not stored in the database of authorized commands in this example, the host device 102, 402 can label the command as an unauthorized command and deny the unauthorized command. The codes for encoding and decoding the commands can be unique to and can be used only between the auxiliary device 104, 404 and the host device 102, 402, such that an unauthorized party cannot copy the software utilized by the auxiliary device controller or the host device controller (for example, by unplugging the thumb drive carrying the auxiliary device controller and its software from the host device 102, 402 and plugging the thumb drive into a personal laptop to install the auxiliary device controller's software) to use on an unauthorized hardware device.

The auxiliary controller 408 (and similarly the second microcontroller 170) can utilize its software to get updates directly from the Internet since, in the configuration shown, the auxiliary device 102, 404 is connected to the Internet. Cyber security approaches may be adopted to prevent software update security breaches during the update process. For example, the source and authenticity of any software update can be verified by the auxiliary device 104, 404 every time before an update for the first controller's software is taken place (for example, by checking the publisher's website, reading the update details, and scanning the file with an antivirus program before opening the available update). Alternatively, strong passwords and/or encryption can be used to allow only authorized parties to install the update. If an unauthorized party is trying to install malware during the update either by physically accessing the auxiliary device 104, 404 or remotely controlling the auxiliary device 104, 404 via a wireless connection, the unauthorized party would need to first pass an authentication process by entering the password and/or encryption code known only to the user of the auxiliary device 104, 404. If the authentication process fails, the unauthorized party will not be able to access the auxiliary computer 104, 404 and install such malware.

The host controller 410 (and similarly the first microcontroller 168) and its software may be updated by unplugging the associated memory drive carrying the host controller 410 (and the first controller 168) and its software from the host hub, plugging the memory drive into the auxiliary hub, which is connected to Internet, and conducting an update for the memory drive used to host the host controller 410, 168 and its software. The associated memory drive can then be unplugged from the auxiliary hub and plugged back into the host hub to resume operations.

The host controller 410, 168 can have its software send an encoded name of an application to the auxiliary controller 408 (or the second microcontroller 170). If the host controller 410, 168 recognizes the encoded name, the host controller 410, 168 can decode the encoded name and the auxiliary device 104, 404 is able to run the authorized application and send an output to the host device 102, 402 via the conversion device 152 as described above. If the host controller 410, 168 does not recognize the encoded name of the application, the host controller 410, 168 can label the application as an unauthorized application and deny the request for running the unauthorized application from the host device 102, 402.

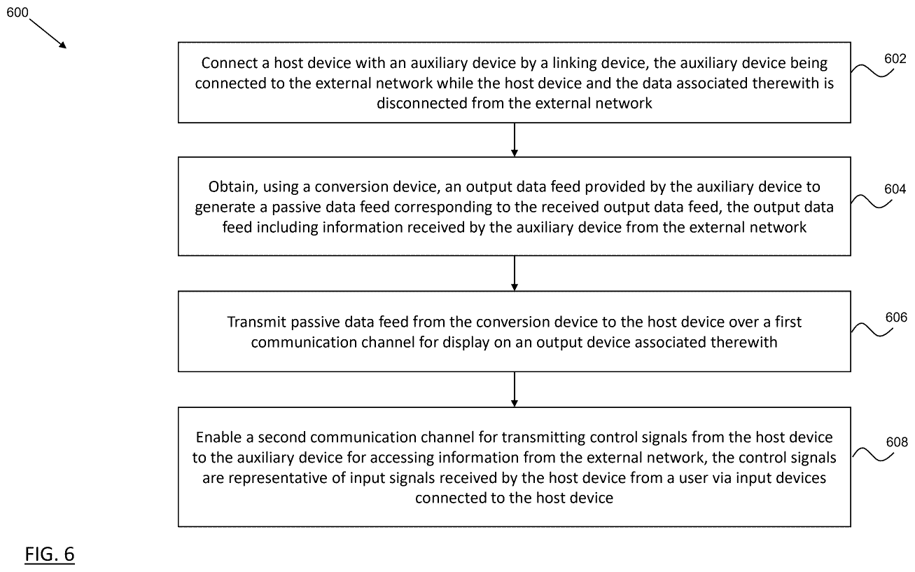

Referring now to FIG. 6, an example method 600 is illustrated for safeguarding a host computing device 102, 402 and the associated data 105, 405 from unauthorized access is illustrated.

At step 602, in the embodiment where auxiliary devices 104, 404 are connected to external networks, the host device 102, 402 is connected to an auxiliary device 104, 404 by a linking device 150, 450. In an example implementation, the linking device 150, 450 is configured to connect the host device 102, 402 to the auxiliary device 104, 404 which in turn is connected to the external network 106, 406, thereby enabling the host device 102, 402 to communicate with the external network 106, 406 through the auxiliary device 104, 404. For example, the auxiliary device 104, 404 is connected to the external network 106, 406 while the host device 102, 402 and consequently the internal data repository 105, 405 associated with the host device 102, 402 remain disconnected from the external network 106 and are connected only to the internal network 107, 407.

At step 604, an output data feed provided by the auxiliary device 104, 404 is captured by a conversion device 150, 450 to generate a passive data feed corresponding to the received output data feed. The output data feed includes information and content that is received by the auxiliary device 104, 404 from the external network 106, 406. For example, the auxiliary device 104, 404 can include a monitor port (e.g., HDMI) that outputs a media feed (including video and audio output) corresponding to the application being run or displayed on the auxiliary device display 112 of the auxiliary device 104, 404. In an example, the conversion device 152 is implemented as an HDMI capture device or any other screen “capturing” device that is configured to capture or record the media feed of the screen displayed on the auxiliary device 104, 404 and generate a passive data feed (or recording) to be relayed or transmitted to and displayed on the display device 111, 411 of the host device 102, 402.

At step 606, the passive data feed is transmitted from the conversion device 152 to the host device 102, 402 over a first communication channel 158 for display on the output device, such as a display monitor 111, 411 of the host device 102, 402. In an example, the first communication channel 158 is a unidirectional pipeline and optionally includes a physical USB cable or hub 160 connected to a corresponding computer port 162 provided in the host device 102, 402. In an embodiment, the host device 102, 402 can include a computer portal 165, 465 configured process and convert the received passive data feed for display on the output device 111, 411 connected to the host device 102, 402. In an example, the computer portal 165, 465 can be implemented as an OpenCV module running on the host device 102, 402 and configured to display the received passive data feed in a window 502 on the display monitor (output device 111, 411) of the host device 102, 402.

Further, at step 608, a second communication channel 166 is enabled for transmitting control signals from the host device 102, 402 to the auxiliary device 104, 404 for accessing information from the external network 106, 406. The control signals are representative of input signals received by the host device 102, 402 from a user via input devices 109, 409 connected to the host device 102, 402. In an example, the second communication channel 166 is an analog communication channel configured to permit transmission of input control signals as electrical signals from the host device 102 to the auxiliary device 104. These input control signals are processed or converted into control signals by the computer portal 165 for transmission over the second communication channel 166 to the auxiliary device 104, 404. For example, the computer portal 165 captures the input signals provided by the user by capturing the corresponding mouse and keyboard manipulation displayed on the display device 111, 411 of the host device 102, 402. In an embodiment, the host device 102, 402 includes a first microcontroller 168, 410 and the auxiliary device 104, 404 similarly includes a second microcontroller 170, 408 configured to communicate with each other, for example, by pin readout, to establish the analog second communication channel 166 for transmitting the input control signals from the host device 102, 402 to the auxiliary device 104, 404. In an example, the second communication channel 166 is also a unidirectional pipeline configured to permit transmission of control signals from the host device 102, 402 to the auxiliary device 104, 404 and not vice-versa. As the user transmits input signals using the host device 102, 402, the input signals are captured by the computer portal 165, 465, transmitted by the first microcontroller 168, 410 and received by the second microcontroller 170, 408 which functions like a simulated mouse and keyboard on the auxiliary device 104, 404. This enables the functionality of the peripheral input devices on the auxiliary device 104, 404 without requiring the dedicated hardware. Further, the display screen of the auxiliary device 104, 404 is continuously captured and displayed on the display monitor 111, 411 of the host device 102, 402 via the first unidirectional pipeline, and thus, the user can view the same on the window displayed on the host device 102, 402 in real time or near real-time.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment(s) and/or computing systems shown herein, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A system for multitasking while safeguarding computing devices and data associated with computing devices from unauthorized access, the system comprising:
at least one linking device configured to connect a host computing device to at least one auxiliary computing device, the linking device including:
a data conversion device configured to capture an output data feed from the auxiliary computing device and provide a passive data feed;
a first communication channel configured to transmit the passive data feed from the data conversion device to the host computing device for display on an output device associated therewith; and
a second communication channel for transmitting control signals from the host computing device to the auxiliary computing device, the control signals being representative of one or more input signals received by the host computing device from a user via one or more input devices connected to the host computing device.

2. The system of claim 1, where software on the host computing device integrates at least one such linking device into a portal on the host computing device, the software on the host computing device pairing the first and second communication channels.

3. The system of claim 2, wherein each auxiliary computing device is configured to be constrained to provide access to a specific operating system or subset of applications therein.

4. The system of claim 3, wherein the subset of applications is a single dedicated application.

5. The system of claim 3, wherein at least one of the subset of applications interacts with an external network via a security protocol.

6. The system of claim 2, wherein each auxiliary device is connected to an external network, a local network, or an intranet, each with a corresponding security protocol or security system.

7. The system of claim 6, wherein at least one auxiliary device is not connected to any network.

8. The system of claim 6, configured to enable customization of network access and security to applications on the auxiliary devices.

9. The system of claim 1, wherein the linking device is configured to physically connect the host computing device and the auxiliary computing device.

10. The system of claim 1, wherein the data conversion device is a screen recording device or capture device configured to acquire data output and transmit the acquired feed as a passive data feed to the host computing device for display on the output device associated therewith, the passive data feed being a media data feed including video or sound data representative of the data output on the auxiliary computing device.

11. The system of claim 10, wherein the data output on the auxiliary computing device is not stored beyond a time of its display to a user.

12. The system of claim 10, wherein the capture device is a high-definition multimedia interface (HDMI) streaming device connected to the auxiliary computing device by an HDMI port that is configured to transmit HDMI media data feed as the output data feed to the portal on the host computing device.

13. The system of claim 1, wherein the first communication channel is part of a first data flow channel configured to enable transmission of data from the auxiliary computing device to the host computing device and prohibit data transmission from the host computing device to the auxiliary computing device.

14. The system of claim 1, wherein the host computing device includes a computer software portal, configured to display the received passive data feed from the capture device onto the output device associated with the host computing device.

15. The system of claim 1, wherein the second communication channel is a data transfer channel comprising:
a first control device associated with the host computing device supplying control data to the at least one portal;
a second control device, including connecting the at least one portal to an emulator of a control device which emulates at least one first control device, and which registers as a control device when connected to an auxiliary computing device.

16. The system of claim 15, wherein the first control device and the second control device are configured to communicate with each other by physical connection occurring through the host computer over hardware ports to establish the data transfer channel.

17. The system of claim 16, wherein control data from the portal on the host computer is sent to the second control device by pin readout.

18. The system of claim 16, wherein the data transfer channel is unidirectional.

19. The system of claim 1, wherein the second communication channel is based on a software emulator of control devices configured to receive control data from the first control device and transfer the control data to the auxiliary computing device to control input via a rule enabling the communication.

20. The system of claim 15, wherein the host computing device includes a computer portal configured to convert one or more user inputs received via the one or more input devices connected to the host computing device into electrical signals to be transmitted to the auxiliary computing device over the second communication channel.

21. The system of claim 20, wherein the auxiliary computing device includes control software to convert the electrical signals received over the second communication channel to corresponding input control signals to be displayed on a display device associated with the auxiliary computing device.

22. A method for multitasking while safeguarding computing devices and data associated with computing devices from unauthorized access, the method comprising:
connecting, by at least one linking device, a host computing device to at least one auxiliary computing device;
capturing, by a data conversion device, an output data feed from the auxiliary computing device and providing a passive data feed;
transmitting, by a first communication channel, the passive data feed from the data conversion device to the host computing device for display on an output device associated therewith; and
transmitting, by a second communication channel, control signals from the host computing device to the auxiliary computing device, the control signals being representative of one or more input signals received by the host computing device from a user via one or more input devices connected to the host computing device.

23. A non-transitory computer-readable medium storing computer executable instructions that, when executed by a processor of a computing device, cause the computing device to perform operations comprising:
connecting, by at least one linking device, a host computing device to at least one auxiliary computing device;
capturing, by a data conversion device, an output data feed from the auxiliary computing device and providing a passive data feed;
transmitting, by a first communication channel, the passive data feed from the data conversion device to the host computing device for display on an output device associated therewith; and
transmitting, by a second communication channel, control signals from the host computing device to the auxiliary computing device, the control signals being representative of one or more input signals received by the host computing device from a user via one or more input devices connected to the host computing device.
